(19) United States
(12) Patent Application Publication
(10) Pub. No.: US 2024/0113619 A1
(43) Pub. Date: Apr. 4, 2024

(54) VOLTAGE CONVERSION CIRCUIT, VOLTAGE CONVERTER, AND CHIP

(71) Applicant: Southchip Semiconductor Technology (Shanghai) Co., Ltd., Shanghai (CN)

(72) Inventor: Wei Zhao, Shanghai (CN)

(73) Assignee: Southchip Semiconductor Technology (Shanghai) Co., Ltd., Shanghai (CN)

(21) Appl. No.: 18/329,573

(22) Filed: Jun. 5, 2023

(30) Foreign Application Priority Data
Sep. 28, 2022 (CN) 202211192849.4

(51) Int. Cl. H02M 3/07

(52) U.S. Cl. CPC H02M 3/07

(57) ABSTRACT

A voltage conversion circuit, a voltage converter, and a chip are provided. The voltage conversion circuit includes: an input switch, a switch assembly, a first clamp circuit, a first capacitor, and a second capacitor. The input switch is connected to a voltage input terminal and a first plate of the first capacitor, the first clamp circuit is connected across two terminals of the input switch, the first capacitor are connected to a voltage output terminal and grounded via the switch assembly, and the voltage output terminal is grounded via the second capacitor. The first clamp circuit is configured to limit a voltage across the two terminals of the input switch. The first clamp circuit is capable of reducing the voltage across the two terminals of the input switch, such that a switch with a low withstand voltage is selected and hence a conversion efficiency is improved.

### CROSS-REFERENCE TO RELATED APPLICATION

This application claims the priority benefit of China application serial no. 202211192849.4, filed on Sep. 28, 2022. The entirety of the above-mentioned patent application is hereby incorporated by reference herein and made a part of this specification.

### BACKGROUND

### Technical Field

Embodiments of the present disclosure relate to the technical field of voltage conversion, and in particularly, relate to a voltage conversion circuit, a voltage converter, and a chip.

### Description of Related Art

A charge pump is also referred to as a switched capacitor voltage converter, and the charge pump is a direct current (DC)-DC converter which stores energy using a capacitor. Since a circuit of the charge pump does not include an inductor, a power consumption of the charge pump is low in use, and therefore, the charge pump may be widely used in various fields. The charge pump includes a boost charge pump and a buck charge pump. The boost charge pump is capable of boosting an input voltage and outputting a boosted voltage, and the buck charge pump is capable of bucking an input voltage and outputting a bucked voltage. For example, a ½ buck charge pump is capable of bucking an output voltage to ½ of an input voltage, in other words, the input voltage is twice the output voltage, and an input current is ½ of an output current.

In a conventional ½ buck charge pump circuit, a voltage input terminal is electrically connected to two capacitors via a switch unit, where the switch unit is capable of controlling a series connection state or a parallel connection state of the two capacitors to ensure that the output voltage is ½ of the input voltage.

However, a switch that is directly electrically connected to the voltage input terminal is present in the switch unit. When the charge pump circuit starts or stops operating, it is possible that a voltage across two terminals of the switch is equal to the input voltage, that is, the voltage across the two terminals of the switch is far greater than an operating voltage. In this way, a switch with a high withstand voltage needs to be selected.

### SUMMARY

In view of the above problem, embodiments of the present disclosure provide a voltage conversion circuit, a voltage converter, and a chip.

In a first aspect, an embodiment of the present disclosure provides a voltage conversion circuit. The voltage conversion circuit includes an input switch, a switch assembly, a first clamp circuit, a first capacitor, and a second capacitor. A first terminal of the input switch is electrically connected to a voltage input terminal, a second terminal of the input switch is electrically connected to a first plate of the first capacitor, two plates of the first capacitor are electrically connected to a voltage output terminal via the switch assembly, the two plates of the first capacitor are further grounded via the switch assembly, the voltage output terminal is grounded via the second capacitor, and the first clamp circuit is electrically connected across two terminals of the input switch.

The input switch is configured to, in cooperation with the switch assembly, control an electrical connection between the first capacitor and the second capacitor, such that an output voltage is less than an input voltage.

The first clamp circuit is configured to, in response to the input voltage being greater than a first clamp voltage, limit a voltage across the two terminals of the input switch to the first clamp voltage.

In some embodiments, an output terminal of the first clamp circuit is electrically connected to a control terminal of the input switch. The first clamp circuit is configured to, in response to the input voltage being greater than the first clamp voltage, raise a control voltage of the input switch.

In some embodiments, the first clamp circuit is configured to, in response to the input voltage being greater than the first clamp voltage, raise a voltage at the second terminal of the input switch.

In some embodiments, the first clamp circuit includes a first switch, a first unidirectional diode, a first clamp switch, and a first resistor. A negative terminal of the first clamp switch is electrically connected to the first terminal of the input switch and a positive terminal of the first unidirectional diode, a positive terminal of the first clamp switch is electrically connected to a first terminal of the first resistor and a control terminal of the first switch, a second terminal of the first resistor is electrically connected to the second terminal of the input switch, a negative terminal of the first unidirectional diode is electrically connected to a first terminal of the first switch, and a second terminal of the first switch is electrically connected to the control terminal of the input switch.

In some embodiments, the first clamp circuit includes a second switch, a second unidirectional diode, a second clamp switch, and a second resistor. A first terminal of the second resistor is electrically connected to the first terminal of the input switch and a first terminal of the second switch, a second terminal of the second resistor is electrically connected to a negative terminal of the second clamp switch and a control terminal of the second switch, a positive terminal of the second clamp switch is electrically connected to the second terminal of the input switch, a second terminal of the second switch is electrically connected to a positive terminal of the second unidirectional diode, and a negative terminal of the second unidirectional diode is electrically connected to the control terminal of the input switch.

In some embodiments, the first clamp circuit includes a third switch, a third clamp switch, and a third resistor. A negative terminal of the third clamp switch is electrically connected to the first terminal of the input switch and a first terminal of the third switch, a positive terminal of the third clamp switch is electrically connected to a control terminal of the third switch and a first terminal of the third resistor, and a second terminal of the third resistor is electrically connected to a second terminal of the third switch and the second terminal of the input switch.

In some embodiments, the first clamp circuit further includes a fourth resistor and a fourth switch. The second terminal of the third switch is electrically connected to the second terminal of the input switch via the fourth resistor, a control terminal of the fourth switch is electrically connected to the second terminal of the third switch, and the first terminal of the input switch is electrically connected to the second terminal of the input switch via the fourth switch.

In some embodiments, the first clamp circuit further includes a fifth resistor and a fifth switch. The first terminal of the third switch is electrically connected to the first terminal of the input switch via the fifth resistor, a control terminal of the fifth switch is electrically connected to the first terminal of the third switch, and the first terminal of the input switch is electrically connected to the second terminal of the input switch via the fifth switch.

In some embodiments, the first clamp circuit includes a sixth switch, a fourth clamp switch, and a sixth resistor. A first terminal of the sixth resistor is electrically connected to the first terminal of the input switch and a first terminal of the sixth switch, a second terminal of the sixth resistor is electrically connected to a control terminal of the sixth switch and a negative terminal of the fourth clamp switch, a positive terminal of the fourth clamp switch is electrically connected to a second terminal of the sixth switch and the second terminal of the input switch.

In some embodiments, the first clamp circuit further includes a seventh resistor and a seventh switch. The first terminal of the sixth switch is electrically connected to the first terminal of the input switch via the seventh resistor, a control terminal of the seventh switch is electrically connected to the first terminal of the sixth switch, and the first terminal of the input switch is electrically connected to the second terminal of the input switch via the seventh switch.

In some embodiments, the first clamp circuit further includes an eighth resistor and an eighth switch. The second terminal of the sixth switch is electrically connected to the second terminal of the input switch via the eighth resistor, a control terminal of the eighth switch is electrically connected to the second terminal of the sixth switch, and the first terminal of the input switch is electrically connected to the second terminal of the input switch via the eighth switch.

In some embodiments, the clamp switch includes one of: a Zener diode, a transistor, and a diode.

In some embodiments, the switch assembly includes a ninth switch, a tenth switch, and an eleventh switch. A first terminal of the ninth switch is electrically connected to the first plate of the first capacitor, a second terminal of the ninth switch is electrically connected to the voltage output terminal and a first terminal of the tenth switch, a second terminal of the tenth switch is electrically connected to a first terminal of the eleventh switch and a second plate of the first capacitor, and a second terminal of the eleventh switch is grounded.

In some embodiments, the voltage conversion circuit further includes a third capacitor, and the switch assembly further includes a twelfth switch, a thirteenth switch, and a fourteenth switch. The first terminal of the tenth switch is electrically connected to the second terminal of the ninth switch via the twelfth switch, the first terminal of the tenth switch is further electrically connected to the voltage output terminal via the third capacitor and the thirteenth switch, a first terminal of the fourteenth switch is electrically connected between the third capacitor and the thirteenth switch, and a second terminal of the fourteenth switch is grounded.

In some embodiments, the voltage conversion circuit further includes a fourth capacitor and a fifth capacitor, and the switch assembly further includes a fifteenth switch, a sixteenth switch, a seventeenth switch, and an eighteenth switch. The first terminal of the tenth switch is electrically connected to the second terminal of the ninth switch via the fifteenth switch and the sixteenth switch, the first terminal of the tenth switch is further grounded via the seventeenth switch and the eighteenth switch, a first plate of the fourth capacitor is electrically connected to the second terminal of the ninth switch, a second plate of the fourth capacitor is electrically connected between the seventeenth switch and the eighteenth switch, a first plate of the fifth capacitor is electrically connected between the fifteenth switch and the sixteenth switch, and a second plate of the fifth capacitor is electrically connected between the tenth switch and the eleventh switch.

In some embodiments, the voltage conversion circuit further includes a second clamp circuit, electrically connected across the first terminal and the second terminal of the ninth switch. The second clamp circuit is configured to limit a voltage across the first terminal and the second terminal of the ninth switch to a second clamp voltage.

In a second aspect, an embodiment of the present disclosure provides a voltage converter. The voltage converter includes any voltage conversion circuit according to the first aspect.

In a third aspect, an embodiment of the present disclosure provides a chip, the chip includes any voltage conversion circuit according to the first aspect.

In the technical solutions according to the embodiments of the present disclosure, the voltage conversion circuit includes an input switch, a switch assembly, a first clamp circuit, a first capacitor, and a second capacitor. A first terminal of the input switch is electrically connected to a voltage input terminal, a second terminal of the input switch is electrically connected to a first plate of the first capacitor, two plates of the first capacitor are electrically connected to a voltage output terminal via the switch assembly, the two plates of the first capacitor are further grounded via the switch assembly, the voltage output terminal is grounded via the second capacitor, and the first clamp circuit is electrically connected across two terminals of the input switch. The input switch is capable of in cooperation with the switch assembly, controlling an electrical connection between the first capacitor and the second capacitor, such that an output voltage is less than an input voltage. The first clamp circuit is capable of in response to the input voltage being greater than a first clamp voltage, limiting a voltage across the two terminals of the input switch to the first clamp voltage, that is, the first clamp circuit is capable of reducing a voltage across the two terminals of the input switch. In this way, a switch with a low withstand voltage is selected as the input switch and hence a conversion efficiency of the voltage conversion circuit is improved. This is conducive to reduction of costs and miniaturization of the voltage conversion circuit.

The above description only summarizes the technical solutions of the embodiments of the present disclosure. Specific embodiments of the present disclosure are described hereinafter to better and clearer understand the technical solutions of the embodiments of the present disclosure, to practice the technical solutions based on the disclosure of the specification and to make the above and other objectives, features and advantages of the embodiments of the present disclosure more apparent and understandable.

### BRIEF DESCRIPTION OF THE DRAWINGS

For clearer descriptions of technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a schematic structural diagram of a voltage conversion circuit according to the related art.

FIG. 2 is a schematic structural diagram of a voltage conversion circuit according to an embodiment of the present disclosure.

FIG. 3 is a schematic structural diagram of another voltage conversion circuit according to an embodiment of the present disclosure.

FIG. 4A is an equivalent circuit diagram of the voltage conversion circuit as illustrated in FIG. 3 in a state.

FIG. 4B is an equivalent circuit diagram of the voltage conversion circuit as illustrated in FIG. 3 in another state.

FIG. 5 is a schematic structural diagram of still another voltage conversion circuit according to an embodiment of the present disclosure.

FIG. 6A is an equivalent circuit diagram of the voltage conversion circuit as illustrated in FIG. 5 in a state.

FIG. 6B is an equivalent circuit diagram of the voltage conversion circuit as illustrated in FIG. 5 in another state.

FIG. 7 is a schematic structural diagram of yet still another voltage conversion circuit according to an embodiment of the present disclosure.

FIG. 8A is an equivalent circuit diagram of the voltage conversion circuit as illustrated in FIG. 7 in a state.

FIG. 8B is an equivalent circuit diagram of the voltage conversion circuit as illustrated in FIG. 7 in another state.

FIG. 9 is a schematic structural diagram of yet still another voltage conversion circuit according to an embodiment of the present disclosure.

FIG. 10 is a schematic structural diagram of yet still another voltage conversion circuit according to an embodiment of the present disclosure.

FIG. 11A is a schematic structural diagram of a clamp switch according to an embodiment of the present disclosure.

FIG. 11B is a schematic structural diagram of another clamp switch according to an embodiment of the present disclosure.

FIG. 11C is a schematic structural diagram of still another clamp switch according to an embodiment of the present disclosure.

FIG. 12 is a schematic structural diagram of yet still another voltage conversion circuit according to an embodiment of the present disclosure.

FIG. 13 is a schematic structural diagram of yet still another voltage conversion circuit according to an embodiment of the present disclosure.

FIG. 14 is a schematic structural diagram of yet still another voltage conversion circuit according to an embodiment of the present disclosure.

FIG. 15 is a schematic structural diagram of yet still another voltage conversion circuit according to an embodiment of the present disclosure.

FIG. 16 is a schematic structural diagram of yet still another voltage conversion circuit according to an embodiment of the present disclosure.

FIG. 17 is a schematic structural diagram of yet still another voltage conversion circuit according to an embodiment of the present disclosure.

FIG. 18 is a schematic structural diagram of yet still another voltage conversion circuit according to an embodiment of the present disclosure.

### DESCRIPTION OF THE EMBODIMENTS

For clearer descriptions of the objectives, technical solutions, and advantages of the embodiments of the present disclosure, the following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

Unless defined otherwise, all technical and scientific terms used herein have the same meaning as commonly understood by one of ordinary skill in the art to which this disclosure pertains. The terms used herein in the specification of present disclosure are only intended to illustrate the specific embodiments of the present disclosure, instead of limiting the present disclosure. The terms “comprise,” “include,” and any variations thereof in the specification, claims, and the description of the drawings of the present disclosure are intended to cover a non-exclusive inclusion.

The terms “example” and “embodiment” in this specification signify that the specific characteristic, structures or features described with reference to the embodiments may be covered in at least one embodiment of the present disclosure. The term “embodiment” when used in various positions of the description, neither indicates the same embodiment, nor indicates an independent or optional embodiment that is exclusive of the other embodiments. A person skilled in the art would implicitly or explicitly understand that the embodiments described in this specification may be incorporated with other embodiments.

Terms such as “first”, “second,” and the like in the specifications, claims and the accompanying drawings of the present disclosure are intended to distinguish different objects but are not intended to define a specific sequence. Such terms may explicitly or implicitly indicate one or more such features.

In the description of the present disclosure, unless otherwise explicitly specified and defined, the terms “connected,” “coupled,” and derivatives forms thereof shall be understood in a broad sense. For example, the terms “connected,” “coupled,” and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is conducted, or communication between the interiors of two elements. The signal connection, in addition to signal connection via a circuitry, may also be signal connection via a communication medium, for example, radio waves.

The term “and/or” is merely an association relationship for describing associated objects, which represents that there may exist three types of relationships, for example, A and/or B may represent three situations: A exists, both A and B exist, and B exists. In addition, the symbol “/” generally represents an “or” relationship between associated objects before and after the symbol.

In the description of the embodiments of the present disclosure, the terms “a plurality of” and “at least two” signify two or more, unless otherwise specified. Likewise, the terms “a plurality of groups” and “at least two groups” signify two or more groups (including two groups).

To make a person skilled in the art better understand the technical solutions of the embodiments of the present disclosure, the technical solutions of the present disclosure are clearly and completely described with reference to the accompanying drawings of the embodiments of the present disclosure.

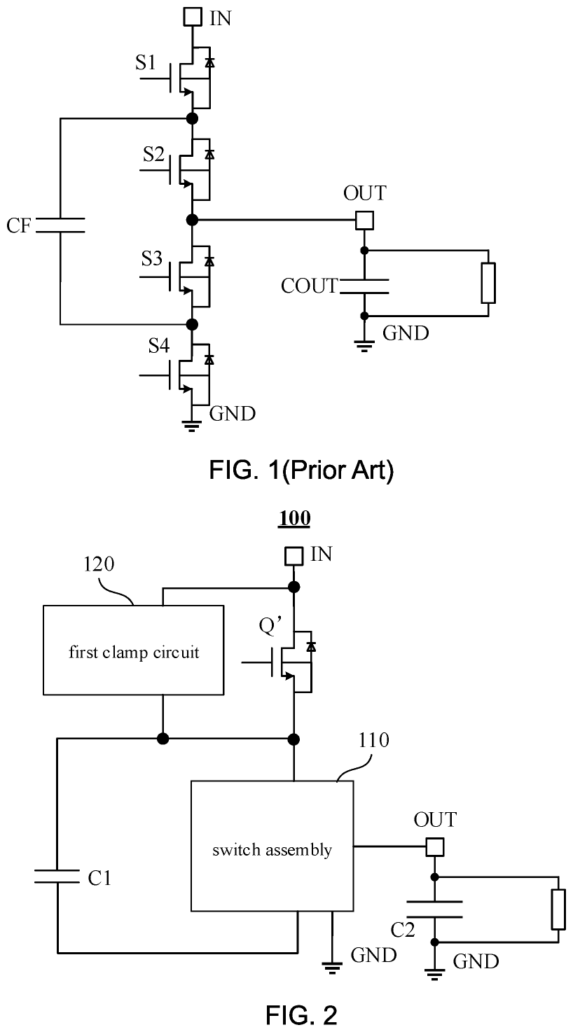

FIG. 1 is a schematic structural diagram of a voltage conversion circuit according to the related art. As illustrated in FIG. 1, the voltage converter circuit includes: a fly capacitor CF, an output capacitor COUT, and a switch unit. The switch unit includes four switches, i.e., S1, S2, S3, and S4.

A 2:1 voltage conversion circuit is connected between a voltage input terminal (IN) and a voltage output terminal (OUT), and in this case, an output voltage Vout is ½ of an input voltage Vin. The voltage input terminal is electrically connected to a first terminal of the switch S1, a second terminal of the switch S1 is electrically connected to a first plate of the fly capacitor CF and a first terminal of the switch S2, a second terminal of the switch S2 is electrically connected to a first terminal of the switch S3, a first plate of the output capacitor COUT, and the voltage output terminal, a second terminal of the switch S3 is connected to a second plate of the fly capacitor CF and a first terminal of the switch S4, a second terminal of the switch S4 is grounded, and a second plate of the output capacitor COUT is grounded.

Exemplarily, the fly capacitor CF and the output capacitor COUT are capacitors of the same specification. When the voltage conversion circuit operates normally, a voltage on the first plate of the fly capacitor CF is switched between the input voltage Vin and the output voltage Vout, and a voltage on the second plate of the fly capacitor CF is switched between the output voltage Vout and 0 V, such that the output voltage Vout is half of the input voltage Vin. For example, the input voltage Vin is 10 V, and the output voltage Vout is 5 V. In the meantime, a voltage across the two terminals of the switch S1, a voltage across the two terminals of the switch S2, a voltage across the two terminals of the switch S3, and a voltage across the two terminals of the switch S4 are all switched between 0 and Vout.

Nevertheless, when the voltage conversion circuit starts or stops operating, the output voltage Vout may be 0 and then the voltage on the first plate of the fly capacitor CF may also be 0. In this case, the voltage across the two terminals of the switch S1 is the input voltage Vin. As such, a switch with a withstand voltage equal to the input voltage Vin needs to be employed as the switch S1. For example, based on the above embodiment, the switch S1 is a switch with a withstand voltage of 10 V. Apparently, the input voltage Vin is twice the output voltage Vout, and the input voltage Vin is greater. Therefore, a switch with a high withstand voltage needs to be employed as the switch S1.

To solve the above technical problem, the embodiments of the present disclosure provide a voltage conversion circuit. The voltage conversion circuit includes an input switch, a switch assembly, a first clamp circuit, a first capacitor, and a second capacitor. A first terminal of the input switch is electrically connected to a voltage input terminal, a second terminal of the input switch is electrically connected to a first plate of the first capacitor, two plates of the first capacitor are electrically connected to a voltage output terminal via the switch assembly, the two plates of the first capacitor are further grounded via the switch assembly, the voltage output terminal is grounded via the second capacitor, and the first clamp circuit is electrically connected across two terminals of the input switch. The input switch is capable of in cooperation with the switch assembly, controlling an electrical connection between the first capacitor and the second capacitor, such that an output voltage is less than an input voltage. The first clamp circuit is capable of in response to the input voltage being greater than a first clamp voltage, limiting a voltage across the two terminals of the input switch to the first clamp voltage, that is, the first clamp circuit is capable of reducing a voltage across the two terminals of the input switch. In this way, a switch with a low withstand voltage is selected as the input switch and hence a conversion efficiency of the voltage conversion circuit is improved. This is conducive to reduction of costs and miniaturization of the voltage conversion circuit.

FIG. 2 is a schematic structural diagram of a voltage conversion circuit according to an embodiment of the present disclosure. As illustrated in FIG. 2, a voltage conversion circuit 100 includes an input switch Q′, a switch assembly 110, a first clamp circuit 120, a first capacitor C1, and a second capacitor C2.

A first terminal of the input switch Q′ is electrically connected to a voltage input terminal IN, a second terminal of the input switch Q′ is electrically connected to a first plate of the first capacitor C1, two plates of the first capacitor C1 are electrically connected to a voltage output terminal OUT via the switch assembly 110, the two plates of the first capacitor C1 are further grounded via the switch assembly 110, the voltage output terminal OUT is grounded via the second capacitor C2, and the first clamp circuit 120 is electrically connected across the two terminals of the input switch Q′.

The input switch Q′ is configured to, in cooperation with the switch assembly 110, control an electrical connection between the first capacitor C1 and the second capacitor C2, such that an output voltage Vout is less than an input voltage Vin. The first clamp circuit 120 is configured to, in response to the input voltage being greater than a first clamp voltage Vclamp1, limit a voltage across the two terminals of the input switch Q′ to the first clamp voltage Vclamp1.

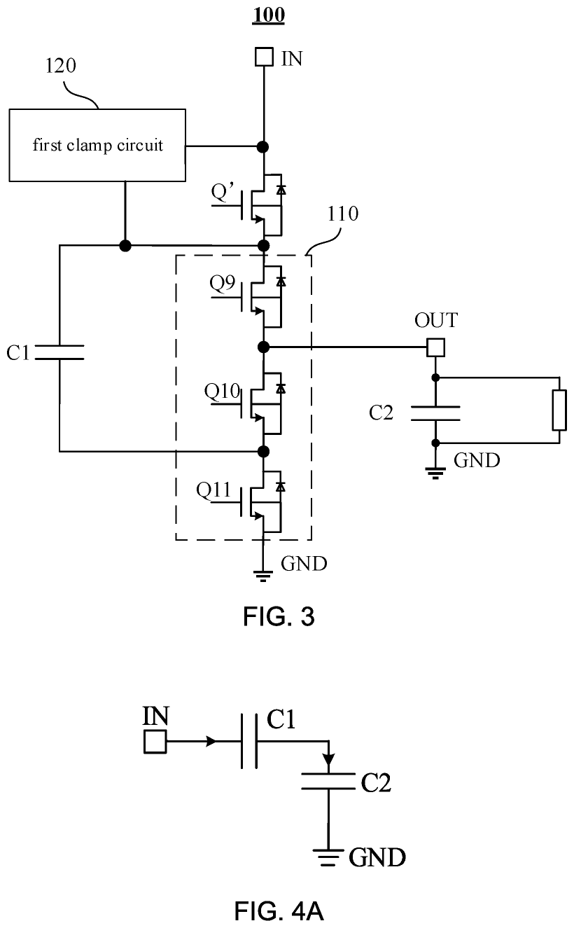

Exemplarily, FIG. 3 is a schematic structural diagram of another voltage conversion circuit according to an embodiment of the present disclosure. As illustrated in FIG. 3, based on the embodiment as illustrated in FIG. 2, the voltage conversion circuit 100 may be a 2:1 voltage conversion circuit, that is, Vout=Vin/2. As illustrated in FIG. 3, the switch assembly 110 includes a ninth switch Q9, a tenth switch Q10, and an eleventh switch Q11. A first terminal of the ninth switch Q9 is electrically connected to the second terminal of the input switch Q′ and the first plate of the first capacitor C1, a second terminal of the ninth switch Q9 is electrically connected to the voltage output terminal OUT and a first terminal of the tenth switch Q10, a second terminal of the tenth switch Q10 is electrically connected to a first terminal of the eleventh switch Q11 and a second plate of the first capacitor C1, and a second terminal of the eleventh switch Q11 is grounded.

As illustrated in FIG. 3, the first terminal of the input switch Q′ is electrically connected to the voltage input terminal IN and a first terminal of the first clamp circuit 120, the second terminal of the input switch Q′ is electrically connected to the first terminal of the ninth switch Q9, the first plate of the first capacitor C1, and a second terminal of the first clamp circuit 120, the second terminal of the ninth switch Q9 is electrically connected to a first plate of the second capacitor C2, the first terminal of the tenth switch Q10, and the voltage output terminal OUT, the second terminal of the tenth switch Q10 is electrically connected to the first terminal of the eleventh switch Q11 and the second plate of the first capacitor C1, the second terminal of the eleventh switch Q11 is grounded, and a second plate of the second capacitor C2 is grounded.

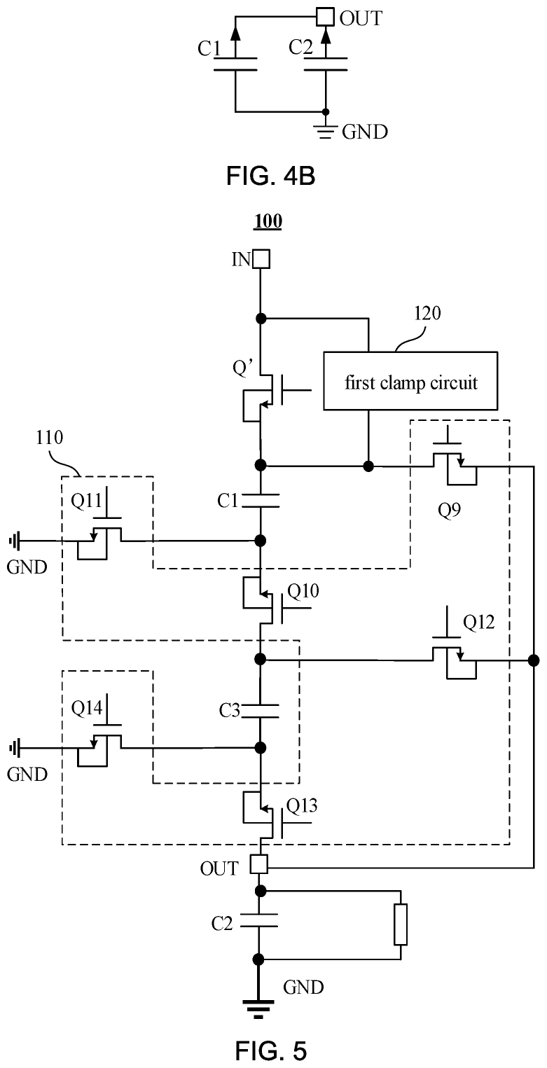

When the voltage conversion circuit 100 normally operates, the input switch Q′ and the tenth switch Q10 are both turned on, and the ninth switch Q9 and the eleventh switch Q11 are both turned off. As illustrated in FIG. 4A, the first capacitor C1 and the second capacitor C2 are connected in series, the first capacitor C1 and the second capacitor C2 are in a charging state, and energy provided by the input voltage Vin is stored in the first capacitor C1 and the second capacitor C2. Upon completion of charging, a voltage across the two terminals of the first capacitor C1 and a voltage across the two terminals of the second capacitor C2 are both half of the input voltage Vin. Afterwards, the ninth switch Q9 and the eleventh switch Q11 are both turned on, and the input switch Q′ and the tenth switch Q10 are both turned off. As illustrated in FIG. 4B, the first capacitor C1 and the second capacitor C2 are connected in parallel, the first capacitor C1 and the second capacitor C2 are in a discharging state, and the energy stored in the first capacitor C1 and the second capacitor C2 is released. In this case, the voltage conversion circuit 100 outputs a voltage, and the output voltage Vout is the voltage across the two terminals of the second capacitor C2, that is, Vout=Vin/2. As such, by controlling a connection between the first capacitor C1 and the second capacitor C2, the output voltage may be controlled to be equal to half of the input voltage Vin, that is, Vout=Vin/2.

When the voltage conversion circuit 100 starts or stops operating, the ninth switch Q9, the tenth switch Q10, and the eleventh switch Q11 are all turned off, the output voltage Vout is 0. In this case, a voltage on the first plate of the first capacitor C1 is 0 V, and thus the voltage across the two terminals of the input switch Q′ is the input voltage Vin. In the case that the input voltage Vin is less than the first clamp voltage Vclamp1 of the first clamp circuit 120, that is, Vin<Vclamp1, where the Vclamp1 is less than a maximum withstand voltage of the input switch Q′, the input switch Q′ is maintained in an off state, and the first clamp circuit 120 is in a non-operating state. In this case, the voltage on the first plate of the first capacitor C1 and a voltage on the second plate of the first capacitor C1 are both 0, a voltage across the two terminals of the ninth switch Q9, a voltage across the two terminals of the tenth switch Q10, and a voltage across the two terminals of the eleventh switch Q11 are all 0, and the voltage Vin across the two terminals of the input switch Q′ is less than the maximum withstand voltage of the input switch Q′.

In a case that the input voltage Vin is greater than the first clamp voltage Vclamp1 of the first clamp circuit 120, that is, Vin>Vclamp1, the first clamp circuit 120 is in an operating state, the voltage on the second plate of the first capacitor C1 is 0, and the first clamp circuit 120 may raise the voltage on the first plate of the first capacitor C1 from 0 V to Vin−Vlamp1. In this case, the voltage across the two terminals of the tenth switch Q10 and the voltage across the two terminals of the eleventh switch Q11 are both 0, the voltage across the two terminals of the input switch C′ is Vclamp1, the voltage across the two terminals of the ninth switch Q9 is Vin-Vclamp1, and Vin-Vclamp1 is less than a maximum withstand voltage of the ninth switch Q9.

In addition, the first clamp voltage Vclamp1 may be set to be greater than the output voltage Vout, that is, Vclamp1>Vout, which may not cause any impact on normal operation of the voltage conversion circuit 100.

In summary, the first clamp circuit 120 may limit the voltage across the two terminals of the input switch Q′ to the first clamp voltage Vclamp1, and therefore the voltage across the two terminals of the input switch Q′ is reduced. In this way, a switch with a low withstand voltage may be selected as the input switch Q′. Relative to a switch with a high withstand voltage, the switch with the low withstand voltage has smaller size and lower costs, which is conducive to reduction of costs and miniaturization of the voltage conversion circuit. Further, with respect to two switches of the same size, the switch with a lower withstand voltage has a smaller resistance, and thus the voltage conversion circuit has a higher conversion efficiency.

In some embodiments, the voltage conversion circuit 100 may be a 3:1 voltage conversion circuit. As illustrated in FIG. 5, the voltage conversion circuit 100 includes a first capacitor C1, a second capacitor C2, and a third capacitor C3; and the switch assembly 110 includes a ninth switch Q9, a tenth switch Q10, an eleventh switch Q11, a twelfth switch Q12, a thirteenth switch Q13, and a fourteenth switch Q14.

A first terminal of the ninth switch Q9 is electrically connected to the second terminal of the input switch Q′ and the first plate of the first capacitor C1, a second terminal of the ninth switch Q9 is electrically connected to the voltage output terminal OUT and a first terminal of the tenth switch Q10, a second terminal of the tenth switch Q10 is electrically connected to a first terminal of the eleventh switch Q11 and a second plate of the first capacitor C1, and a second terminal of the eleventh switch Q11 is grounded. The first terminal of the tenth switch Q10 is electrically connected to the second terminal of the ninth switch Q9 via the twelfth switch Q12, the first terminal of the tenth switch Q10 is further electrically connected to the voltage output terminal OUT via the third capacitor C3 and the thirteenth switch Q13, a first terminal of the fourteenth switch Q14 is electrically connected between the third capacitor C3 and the thirteenth switch Q13, and a second terminal of the fourteenth switch Q14 is grounded.

As illustrated in FIG. 5, the first terminal of the input switch Q′ is electrically connected to the voltage input terminal IN and the first terminal of the first clamp circuit 120, the second terminal of the input switch Q′ is electrically connected to the first plate of the first capacitor C1, the second terminal of the first clamp circuit 120, and the first terminal of the ninth switch Q9, the second terminal of the ninth switch Q9 is electrically connected to a first terminal of the twelfth switch Q12, a first terminal of the thirteenth switch Q13, a first plate of the second capacitor C2, and the voltage output terminal OUT, a second terminal of the twelfth switch Q12 is electrically connected to the first terminal of the tenth switch Q10 and a first plate of the third capacitor C3, the second terminal of the tenth switch Q10 is electrically connected to the second plate of the first capacitor C1 and the first terminal of the eleventh switch Q11, a second terminal of the thirteenth switch Q13 is electrically connected to a second plate of the third capacitor C3 and the first terminal of the fourteenth switch Q14, and a second plate of the second capacitor C2, the second terminal of the eleventh switch Q11, and the second terminal of the fourteenth switch Q14 are all grounded.

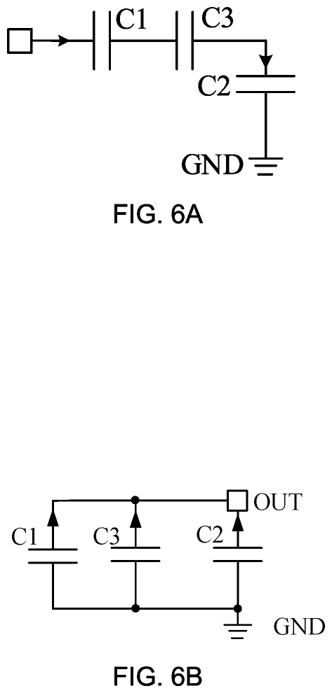

When the voltage conversion circuit 100 normally operates, the input switch Q′, the tenth switch Q10, and the thirteenth switch Q13 are all turned on, and the ninth switch Q9, the eleventh switch Q11, the twelfth switch Q12, and the fourteenth switch Q14 are all turned off. As illustrated in FIG. 6A, the first capacitor C1, the second capacitor C2, and the third capacitor C3 are connected in series, the first capacitor C1, the second capacitor C2, and the third capacitor C3 are in a charging state, and energy provided by the input voltage Vin is stored in the first capacitor C1, the second capacitor C2, and the third capacitor C3. Upon completion of charging, a voltage across the two terminals of the first capacitor C1, a voltage across the two terminals of the second capacitor C2, and a voltage across the two terminals of the third capacitor C3 are all one third of the input voltage Vin, that is, Vin/3. Afterwards, the ninth switch Q9, the eleventh switch Q11, the twelfth switch Q12, and the fourteenth switch Q14 are all turned on, and the input switch Q′, the tenth switch Q10, and the thirteenth switch Q13 are all turned off. As illustrated in FIG. 6B, the first capacitor C1, the second capacitor C2, and the third capacitor C3 are connected in parallel, the first capacitor C1, the second capacitor C2, and the third capacitor C3 are in a discharging state, and the energy stored in the first capacitor C1, the second capacitor C2, and the third capacitor C3 is released. In this case, the voltage conversion circuit 100 outputs a voltage, and the output voltage Vout is the voltage across the two terminals of the second capacitor C2, that is, Vout=Vin/3. As such, by controlling electrical connections of the first capacitor C1, the second capacitor C2, and the third capacitor C3, the output voltage may be controlled to be one third of the input voltage, that is, Vout=Vin/3.

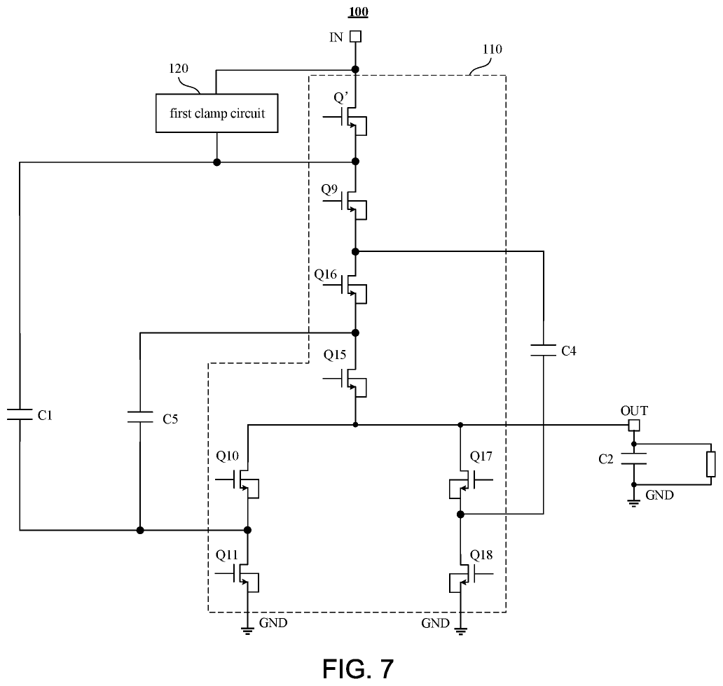

In some embodiments, the voltage conversion circuit 100 may be a 4:1 voltage conversion circuit. As illustrated in FIG. 7, the voltage conversion circuit 100 includes a first capacitor C1, a second capacitor C2, a fourth capacitor C4, and a fifth capacitor C5; and the switch assembly 110 includes a ninth switch Q9, a tenth switch Q10, an eleventh switch Q11, a fifteenth switch Q15, a sixteenth switch Q16, a seventh switch Q17, and an eighteenth switch Q18.

A first terminal of the ninth switch Q9 is electrically connected to the second terminal of the input switch Q′ and the first plate of the first capacitor C1, a second terminal of the ninth switch Q9 is electrically connected to the voltage output terminal OUT and a first terminal of the tenth switch Q10, a second terminal of the tenth switch Q10 is electrically connected to a first terminal of the eleventh switch Q11 and a second plate of the first capacitor C1, and a second terminal of the eleventh switch Q11 is grounded. The first terminal of the tenth switch Q10 is electrically connected to the second terminal of the ninth switch Q9 via the fifteenth switch Q15 and the sixteenth switch Q16, the first terminal of the tenth switch Q10 is further grounded via the seventeenth switch Q17 and the eighteenth switch Q18, a first plate of the fourth capacitor C4 is electrically connected to the second terminal of the ninth switch Q9, a second plate of the fourth capacitor C4 is electrically connected between the seventeenth switch Q17 and the eighteenth switch Q18, a first plate of the fifth capacitor C5 is electrically connected between the fifteenth switch Q15 and the sixteenth switch Q16, and a second plate of the fifth capacitor C5 is electrically connected between the tenth switch Q10 and the eleventh switch Q11.

As illustrated in FIG. 7, the first terminal of the input switch Q′ is electrically connected to the voltage input terminal IN and the first terminal of the first clamp circuit 120, the second terminal of the input switch Q′ is electrically connected to the first plate of the first capacitor C1, the second terminal of the first clamp circuit 120, and the first terminal of the ninth switch Q9, the second terminal of the ninth switch Q9 is electrically connected to the first plate of the fourth capacitor C4 and a first terminal of the sixteenth switch Q16, a second terminal of the sixteenth switch Q16 is electrically connected to a first terminal of the fifteenth switch Q15 and the first plate of the fifth capacitor C5, a second terminal of the fifteenth switch Q15 is electrically connected to the first terminal of the tenth switch Q10, a first terminal of the seventeenth switch Q17, a first plate of the second capacitor C2, and the voltage output terminal OUT, the second terminal of the tenth switch Q10 is electrically connected to the first terminal of the eleventh switch Q11, the second plate of the fifth capacitor C5, and the second plate of the first capacitor C1, a second terminal of the seventeenth switch Q17 is electrically connected to the second plate of the fourth capacitor C4 and a first terminal of the eighteenth switch Q18, and the second terminal of the eleventh switch Q11, a second terminal of the eighteenth switch Q18, and a second plate of the second capacitor C2 are all grounded.

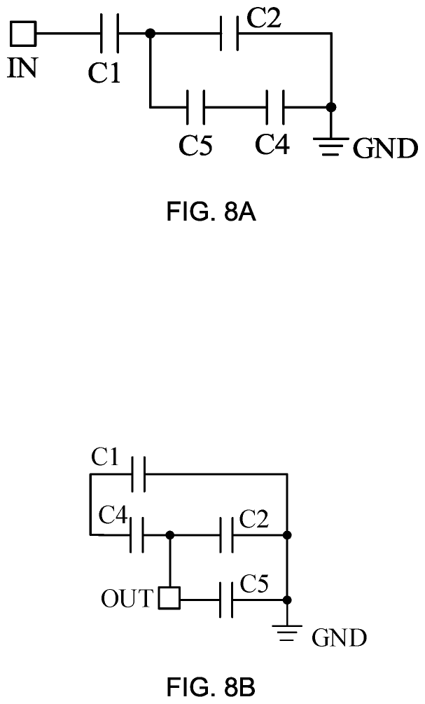

When the voltage conversion circuit 100 normally operates, the input switch Q′, the tenth switch Q10, the sixteenth switch Q16, and the eighteenth switch Q18 are all turned on, and the ninth switch Q9, the eleventh switch Q11, the fifteenth switch Q15, and the seventeenth switch Q17 are all turned off. As illustrated in FIG. 8A, the fourth capacitor C4 and the fifth capacitor C5 are connected in series, and then the series-connected fourth capacitor C4 and fifth capacitor C5 are connected in parallel to the second capacitor C2 and then connected in series to the first capacitor C1; the first capacitor C1, the second capacitor C2, the fourth capacitor C4, and the fifth capacitor C5 are in a charging state; and energy provided by the input voltage Vin is stored in the first capacitor C1, the second capacitor C2, the fourth capacitor C4, and the fifth capacitor C5. Upon completion of charging, a voltage across the two terminals of the second capacitor C2 is Vin/4, and a voltage across the two terminals of the first capacitor C1 is 3Vin/4. Afterwards, the ninth switch Q9, the eleventh switch Q11, the fifteenth switch Q15, and the seventeenth switch Q17 are all turned on, and the input switch Q′, the tenth switch Q10, the sixteenth switch Q16, and the eighteenth switch Q18 are all turned off. As illustrated in FIG. 8B, the second capacitor C2 is connected in parallel to the fifth capacitor C5, and then the parallelly-connected second capacitor C2 and fifth capacitor C5 are connected in series to the fourth capacitor C4 and then connected in parallel to the first capacitor C1; the first capacitor C1 is in a discharging state; and the energy stored in the first capacitor C1 is released. In this case, the voltage conversion circuit 100 outputs a voltage, and the output voltage Vout is the voltage across the two terminals of the second capacitor C2, that is, Vout=Vin/4. As such, by controlling electrical connections of the first capacitor C1, the second capacitor C2, the fourth capacitor C4, and the fifth capacitor C5, the output voltage may be controlled to be one fourth of the input voltage, that is, Vout=Vin/4.

In the embodiments of the present disclosure, a voltage conversion circuit includes an input switch, a switch assembly, a first clamp circuit, a first capacitor, and a second capacitor. A first terminal of the input switch is electrically connected to a voltage input terminal, a second terminal of the input switch is electrically connected to a first plate of the first capacitor, two plates of the first capacitor are electrically connected to a voltage output terminal via the switch assembly, the two plates of the first capacitor are further grounded via the switch assembly, the voltage output terminal is grounded via the second capacitor, and the first clamp circuit is electrically connected across two terminals of the input switch. The input switch is capable of in cooperation with the switch assembly, controlling an electrical connection between the first capacitor and the second capacitor, such that an output voltage is less than an input voltage. The first clamp circuit is capable of in response to the input voltage being greater than a first clamp voltage, limiting a voltage across the two terminals of the input switch to the first clamp voltage, that is, the first clamp circuit is capable of reducing a voltage across the two terminals of the input switch. In this way, a switch with a low withstand voltage is selected as the input switch and hence a conversion efficiency of the voltage conversion circuit is improved. This is conducive to reduction of costs and miniaturization of the voltage conversion circuit.

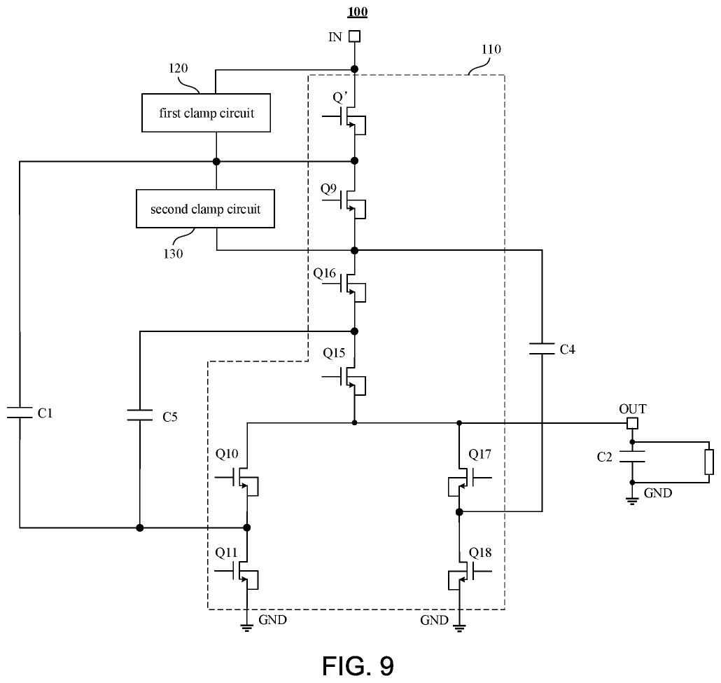

In some embodiments, FIG. 9 is a schematic structural diagram of another voltage conversion circuit according to an embodiment of the present disclosure. As illustrated in FIG. 9, based on the embodiment as illustrated in FIG. 7, the voltage conversion circuit 100 further includes a second clamp circuit 130. The second clamp circuit 130 is electrically connected across the first terminal and the second terminal of the ninth switch Q9. The second clamp circuit 130 is configured to limit a voltage across the first terminal and the second terminal of the ninth switch Q9 to a second clamp voltage Vclamp2.

Exemplarily, as illustrated in FIG. 9, the output voltage Vout of the voltage conversion circuit 100 is Vin/4, that is, Vout=Vin/4, and the first clamp circuit 120 may limit the voltage across the two terminals of the input switch Q′ to the first clamp voltage Vclamp1. In the case that the first clamp voltage Vclamp1 is less, the voltage across the two terminals of the input switch Q′ is less, that is, the voltage withstood by the input switch Q′ is less, such that the voltage withstood by the ninth switch Q9 is greater. As such, a switch with a high withstand voltage needs to be selected as the ninth switch Q9. Therefore, the second clamp circuit 130 is electrically connected across the two terminals of the ninth switch Q9. The second clamp circuit 130 is capable of limiting the voltage across the two terminals of the ninth switch Q9 to a second clamp voltage Vclamp2, such that the voltage across the two terminals of the ninth switch Q9 is reduced. In this way, a switch with a low withstand voltage may be selected as the ninth switch Q9, such that the conversion efficiency of the voltage conversion circuit may be further improved, and the costs of the voltage conversion circuit may be further lowered. In addition, miniaturization of the voltage conversion circuit may be facilitated.

In the embodiments of the present disclosure, the voltage conversion circuit further includes a second clamp circuit. The second clamp circuit is electrically connected across the first terminal and the second terminal of the ninth switch. The second clamp circuit is capable of limiting the voltage across the first terminal and the second terminal of the ninth switch to the second clamp voltage, and is capable of reducing the voltage across the first terminal and the second terminal of the ninth switch. In this way, a switch with a low withstand voltage may be selected as the ninth switch, such that the conversion efficiency of the voltage conversion circuit may be further improved, and the costs of the voltage conversion circuit may be further lowered. In addition, miniaturization of the voltage conversion circuit may be facilitated.

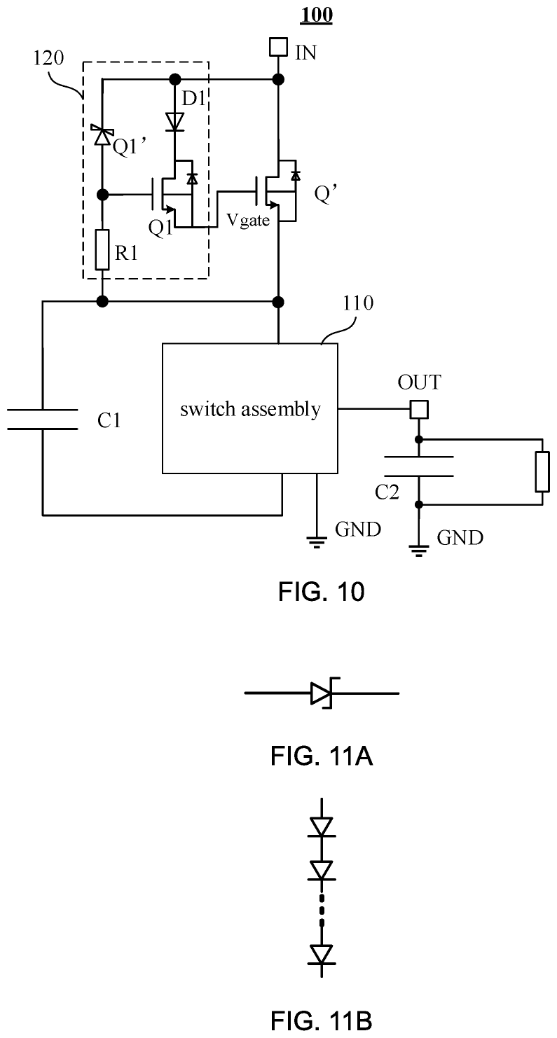

In some embodiments, as illustrated in FIG. 10 which is based on the embodiment as illustrated in FIG. 2, the output terminal of the first clamp circuit 120 is electrically connected to the control terminal of the input switch Q′. The first clamp circuit 120 is configured to raise a control voltage Vgate of the input switch Q′ in the case that the input voltage Vin is greater than the first clamp voltage Vclamp1.

Exemplarily, as illustrated in FIG. 10, the first clamp circuit 120 includes: a first switch Q1, a first unidirectional diode D1, a first clamp switch Q1′, and a first resistor R1. A negative terminal of the first clamp switch Q1′ is electrically connected to the first terminal of the input switch Q′ and a positive terminal of the first unidirectional diode D1, a positive terminal of the first clamp switch Q1′ is electrically connected to a first terminal of the first resistor R1 and a control terminal of the first switch Q1, a second terminal of the first resistor R1 is electrically connected to the second terminal of the input switch Q′, a negative terminal of the first unidirectional diode D1 is electrically connected to a first terminal of the first switch Q1, and a second terminal of the first switch Q1 is electrically connected to the control terminal of the input switch Q′.

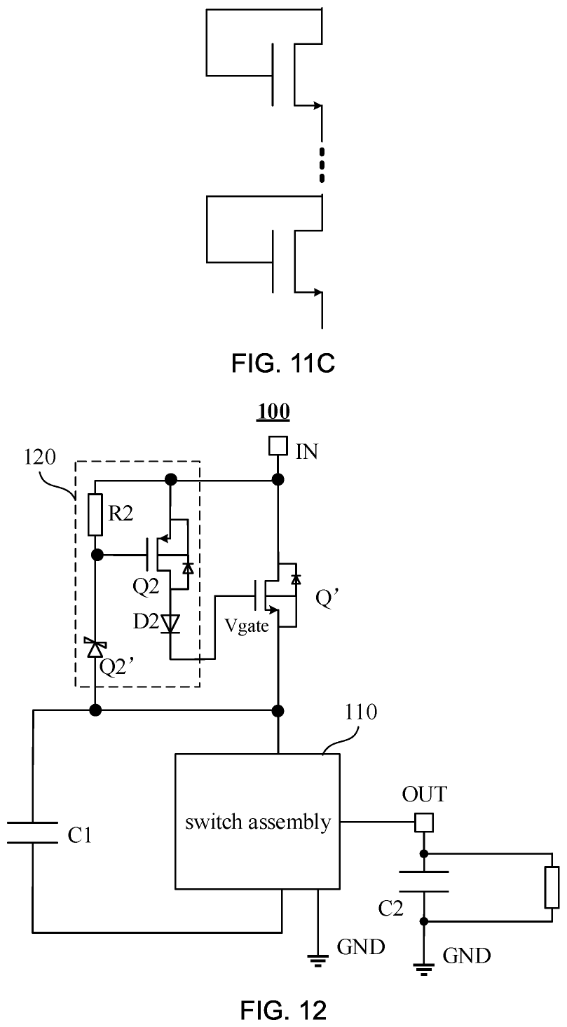

The first clamp switch Q1′ may be a Zener diode, as illustrated in FIG. 11A; the first clamp switch Q1′ may be a diode or series-connected diodes, as illustrated in FIG. 11B; the first clamp switch Q1′ may be a transistor or series-connected transistors, as illustrated in FIG. 11C; the first clamp switch Q1′ may be other circuit structures. Different first clamp circuits Q1′ determine different first clamp voltages Vclamp1. For example, when the first clamp switch Q1′ is a Zener diode, the first clamp voltage Vclamp1 is equal to 5 V. In the present disclosure, the specific structure of the clamp switch is not limited, and in practice a suitable clamp switch may be selected according to a clamp voltage.

As illustrated in FIG. 10, in the case that the input voltage Vin is greater than the first clamp voltage Vclamp1, the first clamp switch Q1′ is turned on, and a voltage at the first terminal of the first resistor R1 is pulled up, that is, a voltage at the control terminal of the first switch Q1 is raised. For example, the first switch Q1 is an n-channel metal-oxide-semiconductor (NMOS) transistor. In this case, the first switch Q1 is turned on, and a voltage at the second terminal of the first switch Q1 is raised, that is, the control voltage Vgate of the input switch Q′ is pulled up, such that the voltage across the two terminals of the input switch Q′ is lowered. In this way, the voltage across the two terminals of the input switch Q′ is the first clamp voltage Vclamp1. As such, the first clamp circuit 120 may turn on the first switch Q1 to raise the control voltage of the input switch Q′ in the case that the input voltage Vin is greater than the first clamp voltage Vclamp1, such that the voltage across the two terminals of the input switch Q′ is the first clamp voltage Vclamp1.

In some embodiments, FIG. 12 is a schematic structural diagram of another voltage conversion circuit according to an embodiment of the present disclosure. As illustrated in FIG. 12, based on the embodiment as illustrated in FIG. 2, the first clamp circuit 120 includes a second switch Q2, a second unidirectional diode D2, a second clamp switch Q2′, and a second resistor R2.

A first terminal of the second resistor R2 is electrically connected to the first terminal of the input switch Q′ and a first terminal of the second switch Q2, a second terminal of the second resistor R2 is electrically connected to a negative terminal of the second clamp switch Q2′ and a control terminal of the second switch Q2, a positive terminal of the second clamp switch Q2′ is electrically connected to the second terminal of the input switch Q′, a second terminal of the second switch Q2 is electrically connected to a positive terminal of the second unidirectional diode D2, and a negative terminal of the second unidirectional diode D2 is electrically connected to the control terminal of the input switch Q′.

As illustrated in FIG. 12, in the case that the input voltage Vin is greater than the first clamp voltage Vclamp1, the second clamp switch Q2′ is turned on, and a voltage at the second terminal of the second resistor R2 is reduced, that is, a voltage at the control terminal of the second switch Q2 is lowered. For example, the second switch Q2 is a p-channel metal-oxide-semiconductor (PMOS) transistor. In this case, the second switch Q2 is turned on, and a voltage at the second terminal of the second switch Q2 is raised, that is, the control voltage Vgate of the input switch Q′ is raised, such that the voltage across the two terminals of the input switch Q′ is reduced. In this way, the voltage across the two terminals of the input switch Q′ is the first clamp voltage Vclamp1. As such, the first clamp circuit 120 may turn on the second switch Q2 to raise the control voltage of the input switch Q′ in the case that the input voltage Vin is greater than the first clamp voltage Vclamp1, such that the voltage across the two terminals of the input switch Q′ is the first clamp voltage Vclamp1.

In some embodiments, the first clamp circuit 120 is configured to raise the voltage at the second terminal of the input switch Q′ in the case that the input voltage Vin is greater than the first clamp voltage Vclamp1.

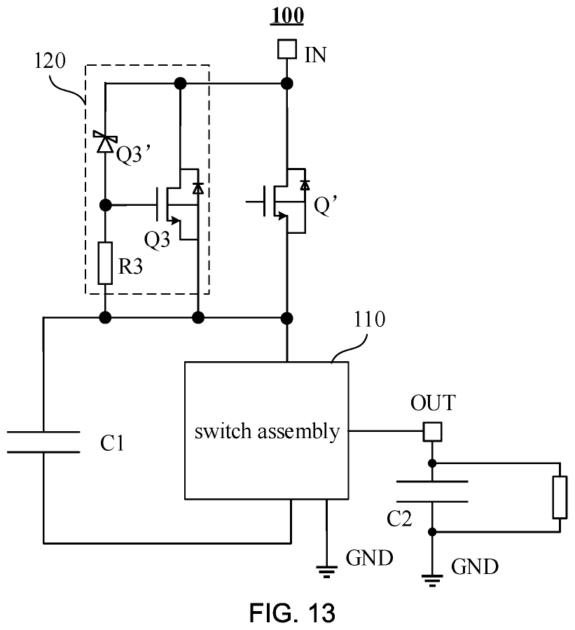

Exemplarily, FIG. 13 is a schematic structural diagram of another voltage conversion circuit according to an embodiment of the present disclosure. As illustrated in FIG. 13, based on the embodiment as illustrated in FIG. 2, the first clamp circuit 120 includes a third switch Q3, a third clamp switch Q3′, and a third resistor R3.

A negative terminal of the third clamp switch Q3′ is electrically connected to the first terminal of the input switch Q′ and a first terminal of the third switch Q3, a positive terminal of the third clamp switch Q3′ is electrically connected to a control terminal of the third switch Q3 and a first terminal of the third resistor R3, and a second terminal of the third resistor R3 is electrically connected to a second terminal of the third switch Q3 and the second terminal of the input switch Q′.

As illustrated in FIG. 13, in the case that the input voltage Vin is greater than the first clamp voltage Vclamp1, the third clamp switch Q3′ is turned on, and a voltage at the first terminal of the third resistor R3 is raised, that is, a voltage at the control terminal of the third switch Q3 is raised. For example, the third switch Q3 is an NMOS transistor. In this case, the third switch Q3 is turned on, and a voltage at the second terminal of the third switch Q3 is raised, such that a voltage across the two terminals of the third switch Q3 is reduced, that is, the voltage across the two terminals of the input switch Q′ is reduced. In this way, the voltage across the two terminals of the input switch Q′ is the first clamp voltage Vclamp1. As such, the first clamp circuit 120 may reduce the voltage across the two terminals of the third switch Q3 in the case that the input voltage Vin is greater than the first clamp voltage Vclamp1, such that the voltage across the two terminals of the input switch Q′ is reduced, such that the voltage across the two terminals of the input switch Q′ is the first clamp voltage Vclamp1.

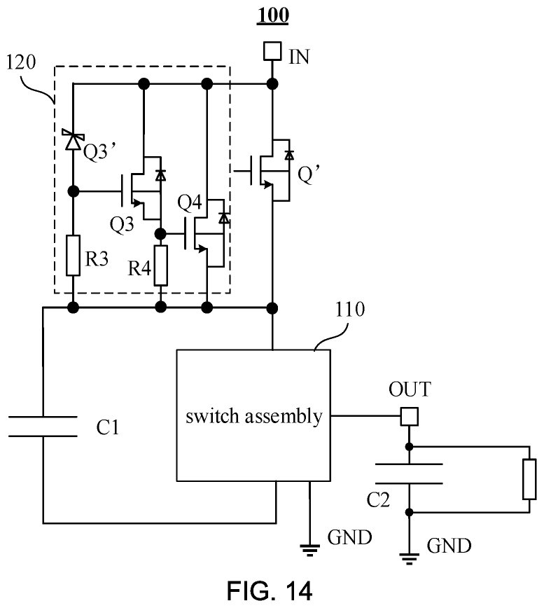

In some embodiments, FIG. 14 is a schematic structural diagram of another voltage conversion circuit according to an embodiment of the present disclosure. As illustrated in FIG. 14, based on the embodiment as illustrated in FIG. 13, the first clamp circuit 120 further includes a fourth resistor R4 and a fourth switch Q4.

The second terminal of the third switch Q3 is electrically connected to the second terminal of the input switch Q′ via the fourth resistor R4, a control terminal of the fourth switch Q4 is electrically connected to the second terminal of the third switch Q3, and the first terminal of the input switch Q′ is electrically connected to the second terminal of the input switch Q′ via the fourth switch Q4.

Exemplarily, as illustrated in FIG. 14, the first terminal of the input switch Q′ is electrically connected to the first terminal of the third switch Q3, a first terminal of the fourth switch Q4, and the negative terminal of the third clamp switch Q3′, the positive terminal of the third clamp switch Q3′ is electrically connected to the control terminal of the third switch Q3 and the first terminal of the third resistor R3, the second terminal of the third switch Q3 is electrically connected to a first terminal of the fourth resistor R4 and the control terminal of the fourth switch Q4, and a second terminal of the fourth switch Q4 is electrically connected to the second terminal of the third resistor R3, a second terminal of the fourth resistor R4, and the second terminal of the input switch Q′.

As illustrated in FIG. 14, in the case that the input voltage Vin is greater than the first clamp voltage Vclamp1, the third clamp switch Q3′ is turned on, and a voltage at the first terminal of the third resistor R3 is raised, that is, a voltage at the control terminal of the third switch Q3 is raised. For example, the third switch Q3 is an NMOS transistor. In this case, the third switch Q3 is turned on, and a voltage at the second terminal of the third switch Q3 is raised, that is, a voltage at the control terminal of the fourth switch Q4 is raised. For example, the fourth switch Q4 is an NMOS transistor. In this case, the fourth switch Q4 is turned on, and a voltage at the second terminal of the fourth switch Q4 is raised, such that a voltage across the two terminals of fourth switch Q4 is reduced, that is, the voltage across the two terminals of the input switch Q′ is lowered. In this way, the voltage across the two terminals of the input switch Q′ is the first clamp voltage Vclamp1. As such, the first clamp circuit 120 may lower the voltage across the two terminals of the fourth switch Q4 in the case that the input voltage Vin is greater than the first clamp voltage Vclamp1, such that the voltage across the two terminals of the input switch Q′ is lowered. In this way, the voltage across the two terminals of the input switch Q′ is the first clamp voltage Vclamp1.

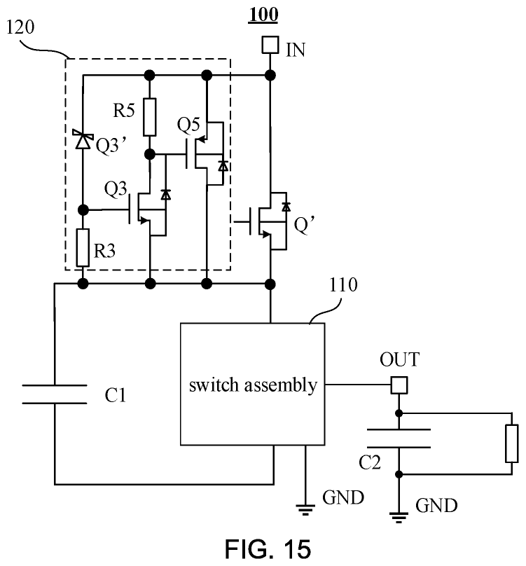

In some embodiments, FIG. 15 is a schematic structural diagram of another voltage conversion circuit according to an embodiment of the present disclosure. As illustrated in FIG. 15, based on the embodiment as illustrated in FIG. 13, the first clamp circuit 120 further includes a fifth transistor R5 and a fifth switch Q5.

The first terminal of the third switch Q3 is electrically connected to the first terminal of the input switch Q′ via the fifth resistor R5, a control terminal of the fifth switch Q5 is electrically connected to the first terminal of the third switch Q3, and the first terminal of the input switch Q′ is electrically connected to the second terminal of the input switch Q′ via the fifth switch Q5.

Exemplarily, as illustrated in FIG. 15, the first terminal of the input switch Q′ is electrically connected to a first terminal of the fifth resistor R5, a first terminal of the fifth switch Q5, and the negative terminal of the third clamp switch Q3′, the positive terminal of the third clamp switch Q3′ is electrically connected to the control terminal of the third switch Q3 and the first terminal of the third resistor R3, the first terminal of the third switch Q3 is electrically connected to a second terminal of the fifth resistor R5 and a control terminal of the fifth switch Q5, and the second terminal of the third switch Q3 is electrically connected to the second terminal of the fifth switch Q5, the second terminal of the third resistor R3, and the second terminal of the input switch Q′.

As illustrated in FIG. 15, in the case that the input voltage Vin is greater than the first clamp voltage Vclamp1, the third clamp switch Q3′ is turned on, and a voltage at the first terminal of the third resistor R3 is raised, that is, a voltage at the control terminal of the third switch Q3 is raised. For example, the third switch Q3 is an NMOS transistor. In this case, the third switch Q3 is turned on, and a voltage at a first terminal of the third switch Q3 is reduced, that is, a voltage at the control terminal of the fifth switch Q5 is reduced. For example, the fifth switch Q5 is a PMOS transistor. In this case, the fifth switch Q5 is turned on, and a voltage at the second terminal of the fifth switch Q5 is raised, such that a voltage across the two terminals of the fifth switch Q5 is reduced, that is, the voltage across the two terminals of the input switch Q′ is reduced. In this way, the voltage across the two terminals of the input switch Q′ is the first clamp voltage Vclamp1. As such, the first clamp circuit 120 may lower the voltage across the two terminals of the fifth switch Q5 in the case that the input voltage Vin is greater than the first clamp voltage Vclamp1, such that the voltage across the two terminals of the input switch Q′ is lowered. In this way, the voltage across the two terminals of the input switch Q′ is the first clamp voltage Vclamp1.

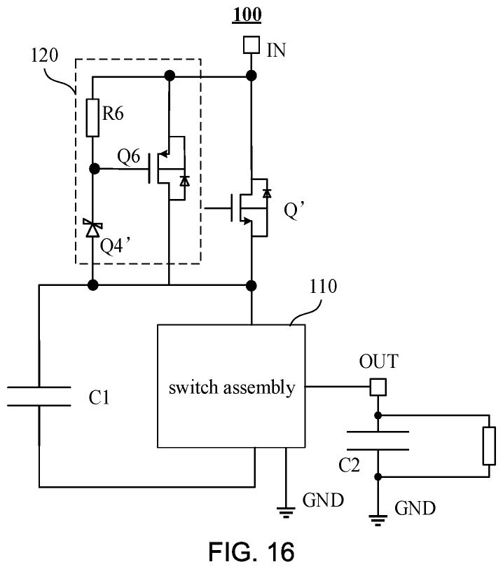

In some embodiments, FIG. 16 is a schematic structural diagram of another voltage conversion circuit according to an embodiment of the present disclosure. As illustrated in FIG. 16, based on the embodiment as illustrated in FIG. 2, the first clamp circuit 120 includes a sixth switch Q6, a fourth clamp switch Q4′, and a sixth resistor R6.

A first terminal of the sixth resistor R6 is electrically connected to the first terminal of the input switch Q′ and a first terminal of the sixth switch Q6, a second terminal of the sixth resistor R6 is electrically connected to a control terminal of the sixth switch Q6 and a negative terminal of the fourth clamp switch Q4′, a positive terminal of the fourth clamp switch Q4′ is electrically connected to the second terminal of the sixth switch Q6 and the second terminal of the input switch Q′.

As illustrated in FIG. 16, in the case that the input voltage Vin is greater than the first clamp voltage Vclamp1, the fourth clamp switch Q4′ is turned on, and a voltage at the second terminal of the sixth resistor R6 is reduced, that is, a voltage at the control terminal of the sixth switch Q6 is reduced. For example, the sixth switch Q6 is a PMOS transistor. In this case, the sixth switch Q6 is turned on, and a voltage at the second terminal of the sixth switch Q6 is raised, such that a voltage across the two terminals of the sixth switch Q6 is reduced, that is, the voltage across the two terminals of the input switch Q′ is reduced. In this way, the voltage across the two terminals of the input switch Q′ is the first clamp voltage Vclamp1. As such, the first clamp circuit 120 may lower the voltage across the two terminals of the sixth switch Q6 in the case that the input voltage Vin is greater than the first clamp voltage Vclamp1, such that the voltage across the two terminals of the input switch Q′ is lowered. In this way the voltage across the two terminals of the input switch Q′ is the first clamp voltage Vclamp1.

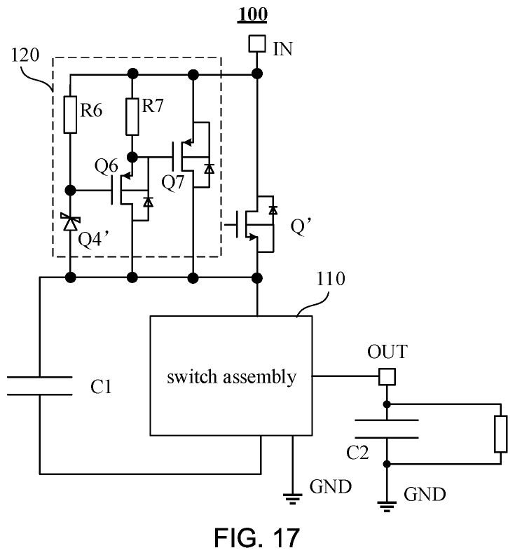

In some embodiments, FIG. 17 is a schematic structural diagram of another voltage conversion circuit according to an embodiment of the present disclosure. As illustrated in FIG. 17, based on the embodiment as illustrated in FIG. 16, the first clamp circuit 120 further includes a seventh resistor R7 and a seventh switch Q7.

The first terminal of the sixth switch Q6 is electrically connected to the first terminal of the input switch Q′ via the seventh resistor R7, a control terminal of the seventh switch Q7 is electrically connected to the first terminal of the sixth switch Q6, and the first terminal of the input switch Q′ is electrically connected to the second terminal of the input switch Q′ via the seventh switch Q7.

Exemplarily, as illustrated in FIG. 17, the first terminal of the sixth resistor R6 is electrically connected to a first terminal of the seventh resistor R7, a first terminal of the seventh switch Q7, and the first terminal of the input switch Q′, the second terminal of the sixth resistor R6 is electrically connected to the negative terminal of the fourth clamp switch Q4′ and the control terminal of the sixth switch Q6, the first terminal of the sixth switch Q6 is electrically connected to a second terminal of the seventh resistor R7 and the control terminal of the seventh switch Q7, and a second terminal of the seventh switch Q7 is electrically connected to the second terminal of the sixth switch Q6, the positive terminal of the fourth clamp switch Q4′, and the second terminal of the input switch Q′.

As illustrated in FIG. 17, in the case that the input voltage Vin is greater than the first clamp voltage Vclamp1, the fourth clamp switch Q4′ is turned on, and a voltage at the second terminal of the sixth resistor R6 is reduced, that is, a voltage at the control terminal of the sixth switch Q6 is lowered. For example, the sixth switch Q6 is a PMOS transistor. In this case, the sixth switch Q6 is turned on, and a voltage at the first terminal of the sixth switch Q6 is reduced, that is, a voltage at the control terminal of the seventh switch Q7 is reduced. For example, the seventh switch Q7 is a PMOS transistor. In this case, the seventh switch Q7 is turned on, and a voltage at the second terminal of the seventh switch Q7 is raised, such that a voltage across the two terminals of the seventh switch Q7 is reduced, that is, the voltage across the two terminals of the input switch Q′ is lowered. In this way, the voltage across the two terminals of the input switch Q′ is the first clamp voltage Vclamp1. As such, the first clamp circuit 120 may reduce the voltage across the two terminals of the seventh switch Q7 in the case that the input voltage Vin is greater than the first clamp voltage Vclamp1, such that the voltage across the two terminals of the input switch Q′ is reduced. In this way the voltage across the two terminals of the input switch Q′ is the first clamp voltage Vclamp1.

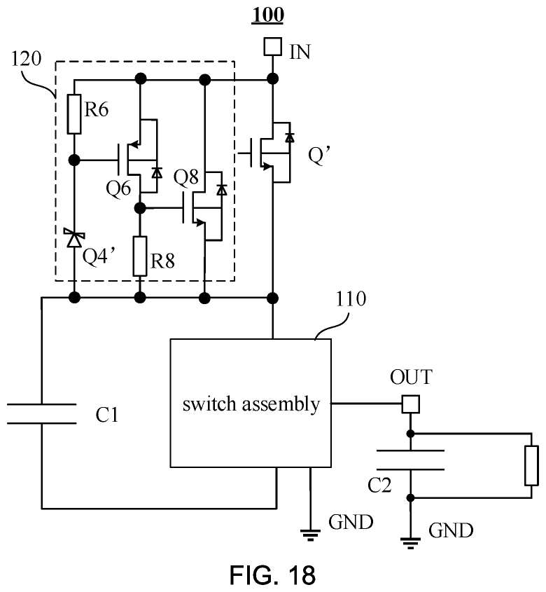

In some embodiments, FIG. 18 is a schematic structural diagram of another voltage conversion circuit according to an embodiment of the present disclosure. As illustrated in FIG. 18, based on the embodiment as illustrated in FIG. 16, the first clamp circuit 120 further includes an eighth resistor R8 and an eighth switch Q8.

The second terminal of the sixth switch Q6 is electrically connected to the second terminal of the input switch Q′ via the eighth resistor R8, a control terminal of the eighth switch Q8 is electrically connected to the second terminal of the sixth switch Q6, and the first terminal of the input switch Q′ is electrically connected to the second terminal of the input switch Q′ via the eighth switch Q8.

Exemplarily, as illustrated in FIG. 18, the first terminal of the sixth resistor R6 is electrically connected to the first terminal of the sixth switch Q6, a first terminal of the eighth switch Q8, and the first terminal of the input switch Q′, the second terminal of the sixth resistor R6 is electrically connected to the negative terminal of the fourth clamp switch Q4′ and the control terminal of the sixth switch Q6, the second terminal of the sixth switch Q6 is electrically connected to a first terminal of the eighth resistor R8 and a control terminal of the eighth switch Q8, and a second terminal of the eighth switch Q8 is electrically connected to a second terminal of the eight resistor R8, the positive terminal of the fourth clamp switch Q4′, and the second terminal of the input switch Q′.

As illustrated in FIG. 18, in the case that the input voltage Vin is greater than the first clamp voltage Vclamp1, the fourth clamp switch Q4′ is turned on, and a voltage at the second terminal of the sixth resistor R6 is reduced, that is, a voltage at the control terminal of the sixth switch Q6 is reduced. For example, the sixth switch Q6 is a PMOS transistor. In this case, the sixth switch Q6 is turned on, and a voltage at the second terminal of the sixth switch Q6 is raised, that is, a voltage at the control terminal of the eighth switch Q8 is raised. For example, the eighth switch Q8 is an NMOS transistor. In this case, the eighth switch Q8 is turned on, and a voltage at the second terminal of the eighth switch Q8 is raised, such that a voltage across the two terminals of eighth switch Q8 is reduced, that is, the voltage across the two terminals of the input switch Q′ is reduced. In this way, the voltage across the two terminals of the input switch Q′ is the first clamp voltage Vclamp1. As such, the first clamp circuit 120 may lower the voltage across the two terminals of the eighth switch Q8 in the case that the input voltage Vin is greater than the first clamp voltage Vclamp1, such that the voltage across the two terminals of the input switch Q′ is lowered. In this way, the voltage across the two terminals of the input switch Q′ is the first clamp voltage Vclamp1.

An embodiment of the present disclosure further provides a voltage converter. The voltage converter includes the voltage conversion circuit 100 according to any one of the above embodiments.

The voltage converter according to the embodiments of the present disclosure may be a charger or a transformer, or may be any other device capable of achieving voltage conversion, which is not limited in the embodiments of the present disclosure.

The voltage converter according to the embodiments of the present disclosure includes the voltage conversion circuit 100 according to any of the above embodiments, and has the same functional modules and achieves the same beneficial effects as the voltage conversion circuit 100, which are thus not described herein any further.

An embodiment of the present disclosure further provides a chip. The chip includes the voltage conversion circuit 100 according to any one of the above embodiments.

Exemplarily, the voltage conversion circuit 100 according to any one of the above embodiments is integrated in the chip, such that the volume of the voltage conversion circuit 100 is reduced, and miniaturization of the voltage conversion circuit 100 is facilitated.

The chip according to the embodiments of the present disclosure includes the voltage conversion circuit 100 according to any of the above embodiments, and has the same functional modules and achieves the same beneficial effects as the voltage conversion circuit 100, which are thus not described herein any further.

Described above are merely specific embodiments of the present disclosure. However, the embodiments of the present disclosure are not limited to those specific ones, and any variations derived by any person skilled in the art would fall within the protection scope of the present disclosure.

In the description of the present disclosure, the word “comprise” or “include” does not exclude the presence of an element or a step not listed in claims. The article “a” or “an” used before an element does not exclude the presence of a plurality of such elements. The present disclosure may be implemented by means of a hardware including several distinct elements and by means of a suitably programmed computer. In a unit claim enumerating several devices, several of the devices may be embodied by one and the same hardware item. Use of the words “first,” “second,” “third,” and the like does not mean any ordering, and may be interpreted as parts of naming. The steps in the above embodiments, unless otherwise specified, shall not be understood as causing limitations to the execution order.

In summary, it should be finally noted that the above-described embodiments are merely for illustration of the present disclosure, but are not intended to limit the present disclosure. Although the present disclosure is described in detail with reference to these embodiments, a person skilled in the art may also make various modifications to the technical solutions disclosed in the embodiments, or make equivalent replacements to a part of the technical features contained therein. Such modifications or replacements, made without departing from the principles of the present disclosure, shall fall within the scope of the present disclosure.

What is claimed is:

1. A voltage conversion circuit, comprising: an input switch, a switch assembly, a first clamp circuit, a first capacitor, and a second capacitor; wherein
a first terminal of the input switch is electrically connected to a voltage input terminal, a second terminal of the input switch is electrically connected to a first plate of the first capacitor, two plates of the first capacitor are electrically connected to a voltage output terminal via the switch assembly, the two plates of the first capacitor are further grounded via the switch assembly, the voltage output terminal is grounded via the second capacitor, and the first clamp circuit is electrically connected across two terminals of the input switch;
the input switch is configured to, in cooperation with the switch assembly, control an electrical connection between the first capacitor and the second capacitor, such that an output voltage is less than an input voltage; and
the first clamp circuit is configured to, in response to the input voltage being greater than a first clamp voltage, limit a voltage across the two terminals of the input switch to the first clamp voltage.

2. The voltage conversion circuit according to claim 1, wherein an output terminal of the first clamp circuit is electrically connected to a control terminal of the input switch; and
the first clamp circuit is configured to, in response to the input voltage being greater than the first clamp voltage, raise a control voltage of the input switch.

3. The voltage conversion circuit according to claim 1, wherein the first clamp circuit is further configured to, in response to the input voltage being greater than the first clamp voltage, raise a voltage at the second terminal of the input switch.

4. The voltage conversion circuit according to claim 2, wherein the first clamp circuit comprises a first switch, a first unidirectional diode, a first clamp switch, and a first resistor;
wherein a negative terminal of the first clamp switch is electrically connected to the first terminal of the input switch and a positive terminal of the first unidirectional diode, a positive terminal of the first clamp switch is electrically connected to a first terminal of the first resistor and a control terminal of the first switch, a second terminal of the first resistor is electrically connected to the second terminal of the input switch, a negative terminal of the first unidirectional diode is electrically connected to a first terminal of the first switch, and a second terminal of the first switch is electrically connected to the control terminal of the input switch.

5. The voltage conversion circuit according to claim 2, wherein the first clamp circuit comprises a second switch, a second unidirectional diode, a second clamp switch, and a second resistor;
wherein a first terminal of the second resistor is electrically connected to the first terminal of the input switch and a first terminal of the second switch, a second terminal of the second resistor is electrically connected to a negative terminal of the second clamp switch and a control terminal of the second switch, a positive terminal of the second clamp switch is electrically connected to the second terminal of the input switch, a second terminal of the second switch is electrically connected to a positive terminal of the second unidirectional diode, and a negative terminal of the second unidirectional diode is electrically connected to the control terminal of the input switch.

6. The voltage conversion circuit according to claim 3, wherein the first clamp circuit comprises a third switch, a third clamp switch, and a third resistor;
wherein a negative terminal of the third clamp switch is electrically connected to the first terminal of the input switch and a first terminal of the third switch, a positive terminal of the third clamp switch is electrically connected to a control terminal of the third switch and a first terminal of the third resistor, and a second terminal of the third resistor is electrically connected to a second terminal of the third switch and the second terminal of the input switch.

7. The voltage conversion circuit according to claim 6, wherein the first clamp circuit further comprises a fourth resistor and a fourth switch;
wherein the second terminal of the third switch is electrically connected to the second terminal of the input switch via the fourth resistor, a control terminal of the fourth switch is electrically connected to the second terminal of the third switch, and the first terminal of the input switch is electrically connected to the second terminal of the input switch via the fourth switch.

8. The voltage conversion circuit according to claim 6, wherein the first clamp circuit further comprises a fifth resistor and a fifth switch;
wherein the first terminal of the third switch is electrically connected to the first terminal of the input switch via the fifth resistor, a control terminal of the fifth switch is electrically connected to the first terminal of the third switch, and the first terminal of the input switch is electrically connected to the second terminal of the input switch via the fifth switch.

9. The voltage conversion circuit according to claim 3, wherein the first clamp circuit comprises a sixth switch, a fourth clamp switch, and a sixth resistor;
wherein a first terminal of the sixth resistor is electrically connected to the first terminal of the input switch and a first terminal of the sixth switch, a second terminal of the sixth resistor is electrically connected to a control terminal of the sixth switch and a negative terminal of the fourth clamp switch, and a positive terminal of the fourth clamp switch is electrically connected to a second terminal of the sixth switch and the second terminal of the input switch.

10. The voltage conversion circuit according to claim 9, wherein the first clamp circuit further comprises a seventh resistor and a seventh switch;
wherein the first terminal of the sixth switch is electrically connected to the first terminal of the input switch via the seventh resistor, a control terminal of the seventh switch is electrically connected to the first terminal of the sixth switch, and the first terminal of the input switch is electrically connected to the second terminal of the input switch via the seventh switch.

11. The voltage conversion circuit according to claim 9, wherein the first clamp circuit further comprises an eighth resistor and an eighth switch;
wherein the second terminal of the sixth switch is electrically connected to the second terminal of the input switch via the eighth resistor, a control terminal of the eighth switch is electrically connected to the second terminal of the sixth switch, and the first terminal of the input switch is electrically connected to the second terminal of the input switch via the eighth switch.

12. The voltage conversion circuit according to claim 4, wherein the first clamp switch is one of: a Zener diode, a transistor, and a diode.

13. The voltage conversion circuit according to claim 1, wherein the switch assembly comprises: a ninth switch, a tenth switch, and an eleventh switch;
wherein a first terminal of the ninth switch is electrically connected to the first plate of the first capacitor, a second terminal of the ninth switch is electrically connected to the voltage output terminal and a first terminal of the tenth switch, a second terminal of the tenth switch is electrically connected to a first terminal of the eleventh switch and a second plate of the first capacitor, and a second terminal of the eleventh switch is grounded.

14. The voltage conversion circuit according to claim 13, wherein the voltage conversion circuit further comprises a third capacitor; and the switch assembly further comprises a twelfth switch, a thirteenth switch, and a fourteenth switch;
wherein the first terminal of the tenth switch is electrically connected to the second terminal of the ninth switch via the twelfth switch, the first terminal of the tenth switch is further electrically connected to the voltage output terminal via the third capacitor and the thirteenth switch, a first terminal of the fourteenth switch is electrically connected between the third capacitor and the thirteenth switch, and a second terminal of the fourteenth switch is grounded.

15. The voltage conversion circuit according to claim 13, wherein the voltage conversion circuit further comprises a fourth capacitor and a fifth capacitor; and the switch assembly further comprises a fifteenth switch, a sixteenth switch, a seventeenth switch, and an eighteenth switch;
wherein the first terminal of the tenth switch is electrically connected to the second terminal of the ninth switch via the fifteenth switch and the sixteenth switch, the first terminal of the tenth switch is further grounded via the seventeenth switch and the eighteenth switch, a first plate of the fourth capacitor is electrically connected to the second terminal of the ninth switch, a second plate of the fourth capacitor is electrically connected between the seventeenth switch and the eighteenth switch, a first plate of the fifth capacitor is electrically connected between the fifteenth switch and the sixteenth switch, and a second plate of the fifth capacitor is electrically connected between the tenth switch and the eleventh switch.

16. The voltage conversion circuit according to claim 15, further comprising: a second clamp circuit, electrically connected across the first terminal and the second terminal of the ninth switch;
wherein the second clamp circuit is configured to limit a voltage across the first terminal and the second terminal of the ninth switch to a second clamp voltage.

17. A voltage converter, comprising: a voltage conversion circuit; wherein the voltage conversion circuit comprises an input switch, a switch assembly, a first clamp circuit, a first capacitor, and a second capacitor;
wherein a first terminal of the input switch is electrically connected to a voltage input terminal, a second terminal of the input switch is electrically connected to a first plate of the first capacitor, two plates of the first capacitor are electrically connected to a voltage output terminal via the switch assembly, the two plates of the first capacitor are further grounded via the switch assembly, the voltage output terminal is grounded via the second capacitor, and the first clamp circuit is electrically connected across two terminals of the input switch;
the input switch is configured to, in cooperation with the switch assembly, control an electrical connection between the first capacitor and the second capacitor, such that an output voltage is less than an input voltage; and
the first clamp circuit is configured to, in response to the input voltage being greater than a first clamp voltage, limit a voltage across the two terminals of the input switch to the first clamp voltage.

18. The voltage converter according to claim 17, wherein an output terminal of the first clamp circuit is electrically connected to a control terminal of the input switch; and
the first clamp circuit is configured to, in response to the input voltage being greater than the first clamp voltage, raise a control voltage of the input switch.

19. A chip, comprising: a voltage conversion circuit; wherein the voltage conversion circuit comprises an input switch, a switch assembly, a first clamp circuit, a first capacitor, and a second capacitor;
wherein a first terminal of the input switch is electrically connected to a voltage input terminal, a second terminal of the input switch is electrically connected to a first plate of the first capacitor, two plates of the first capacitor are electrically connected to a voltage output terminal via the switch assembly, the two plates of the first capacitor are further grounded via the switch assembly, the voltage output terminal is grounded via the second capacitor, and the first clamp circuit is electrically connected across two terminals of the input switch;
the input switch is configured to, in cooperation with the switch assembly, control an electrical connection between the first capacitor and the second capacitor, such that an output voltage is less than an input voltage; and
the first clamp circuit is configured to, in response to the input voltage being greater than a first clamp voltage, limit a voltage across the two terminals of the input switch to the first clamp voltage.

20. The chip according to claim 19, wherein an output terminal of the first clamp circuit is electrically connected to a control terminal of the input switch; and
the first clamp circuit is configured to, in response to the input voltage being greater than the first clamp voltage, raise a control voltage of the input switch.
